(19) United States
(12) Patent Application Publication
(10) Pub. No.: US 2012/0276357 A1
(43) Pub. Date: Nov. 1, 2012

(54) ACTIVE PACKAGING WITH CONTROLLED RELEASE OF TOCOPHEROL

(75) Inventors: Herlinda Soto-Valdez, Hermosillo (MX); Abril Zoraida Graciano-Verdugo, Hermosillo (MX); Elizabeth Peralta, Hermosillo (MX); Cipactli Yuridia, Tepic (MX)

(73) Assignee: CENTRO DE INVESTIGACIÓN EN ALIMENTACIÓN Y DESARROLLO A.C., Hermosillo Sonora (MX)

(21) Appl. No.: 12/672,643

(22) PCT Filed: Aug. 8, 2008
(86) PCT No.: PCT/IB2008/002083

§ 371 Date: Apr. 17, 2012

(30) Foreign Application Priority Data
Aug. 9, 2007 (MX) MX/A/2007/009634

(51) Int. Cl. C09K 15/08; C09K 15/24; B29C 49/04

(52) U.S. Cl. 428/220; 264/540; 252/404; 252/403

(57) ABSTRACT

A material for active antioxidant packaging, flexible or rigid, is described, preferably for foods or products vulnerable to any type of oxidation, the material consists of a system promoting migration of an active component to the packaged product during its storage or marketing; it replaces the direct addition of antioxidants to the packaged product and lengthens its shelf life. This material is formed by ≧89% of base polymer, 3.5 to 10% by weight of tocopherol antioxidant, and 0.1 to 1.0% by weight of any surface modifier having a hydrophobic portion and a hydrophilic portion in its molecule, whose use as additive in contact with foods is approved by FDA.

### BACKGROUND

1. Field of the Invention

This invention belongs to the field of active packaging materials, which deliver antioxidants to protect and extend the shelf life of foods and products vulnerable to oxidation.

Particularly, this invention refers to a material, antioxidant active packaging, flexible or rigid, preferably for foods, for example fresh red meat, dairy products, frozen fish, oils or foods having a high proportion of non-saturated oil; almonds or seeds; powdered whole milk, etc., or any other pharmaceutical or cosmetic products vulnerable to any type of oxidation.

2. Background of the Invention

With the purpose of improving the stability of lipids against oxidation, and to extend the shelf life of foods or products vulnerable to this kind of deterioration, antioxidant agents are used as additives to be directly added to the products. Among the antioxidants used are the synthetic ones and those of natural origin. To the first ones belong butyl-hydroxyanisole (BHA), butyl-hydroxytoluene (BHT), tert-butyl.hydroquinone (TBHQ) and propyl gallate (PG). One of the antioxidants of natural origin most used in foods is α-tocopherol. It is common practice to add antioxidants in relative high quantities during processing or before packaging of foods or products vulnerable to oxidation, so that they are protected for a long time. During the storage and marketing, this initial quantity of additive gradually decreases by exerting its antioxidant action, and eventually is exhausted. This is the moment when oxidation reactions start, and the product starts to deteriorate.

Either BHT, BHA, and α-tocopherol are also used as direct additives to polymers, to protect them against degradation during processing (Al-Malaika S., Issenhuth S. 1999. The antioxidant role of α-tocopherol in polymers III. Nature of transformation products during polyolefins extrusion. Polymer Degradation and Stability 65:143-151).

Since oxidation reactions in foods or in packaged products are initiated at the surface, particularly in the portion that first gets oxygen or light scattered through package walls, systems have been developed using the package as a vehicle for application of antioxidants, mainly applying synthetic antioxidants (Sharma, G. K., Madura, C. and Arya, S. S. 1990. Interaction of plastic films with foods. II. Effect of polyethylene and polypropylene films on the stability of vegetable oils. Journal of Food Science and Technology. 27:328-331). Polyethylene and Polypropylene films were added with BHT and BHA, and tested in contact with sunflower oil; a reduction in the degree of oxidation of the oil was found. Yanidis (1989. Flexible packaging material containing an antioxidant. U.S. Pat. No. 4,880,696) developed a flexible packaging containing a mixture of BHA and BHT which was applied to cereals. Huang C. H. and Weng Y. M. (1998. Inhibition of lipid oxidation in fish muscle by antioxidant incorporated polyethylene film. Journal of Food Processing and Preservation 22:199-209), proved the effectiveness of polyethylene films containing BHT for inhibiting oxidation of lipids in fish-muscle and oil.

Regarding the use of tocopherol in packaging systems, Wessling, C., Nielsen, T. and Leufvén, A. (2000. The influence of α-tocopherol concentration on the stability of linoleic acid and the properties of low-density polyethylene. Packaging Technology and Science 13:1-10) used films impregnated with this antioxidant in linoleic acid emulsions, stored at 6° C., and showing its effectiveness as oxidative stabilizer. In another report, Wessling, C., Nielsen, T., Leufvén, A. and Jägerstad, A. (1998. Mobility of α-Tocopherol and BHT in LDPE in contact with fatty food simulants. Food Additives and Contaminants 15:709-715) showed that the rate of release of α-tocopherol from low-density polyethylene in contact with sunflower oil was lower than that of BHT. This was the first work to show the need of controlling the release of tocopherol towards packaged products. U.S. Pat. No. 7,101,624 describes the migration of BHT, a synthetic antioxidant, from a laminated film. In this patent it is reported that the antioxidant was incorporated to the adhesive bonding the two layers in the laminate, diffusing through the layer destined to be in contact with the food.

Recently, other works have been reported with the aim of reducing the diffusion speed of tocopherol to food simulants. In these cases, ethanol has been used as a fatty food simulant. This simulant has higher extractive power than oil or than any other food, thus over-estimating the migration values. However, there is no need to reduce the migration velocity in foods having a high proportion of water, such as fresh meat, because diffusion of tocopherol in the package-food interface is low. Neither in case of foods stored at refrigeration or freezing temperatures, where the mobility of tocopherol through polymer matrix is low. In the works cited, silica has been used to adsorb α-tocopherol before the addition to low-density polyethylene when processing the film, thus assuring a low release during the product shelf life (Heirlings, L., Siró, I., Devlieghere, F., Bavel, E., Cool, P., De Meulenaer, B., Vansant, E. F. and Debevere, J. 2004. Influence of polymer matrix and adsorption onto silica materials on the migration of α-tocopherol into 95% ethanol from active packaging. Food Additives and Contaminants. 2:1125-1136). This method of addition attained a migration delay for 3.4 days, compared to a film with only α-tocopherol, which took 10.4 days at 7° C.; however, 95% ethanol was used as simulator of a fatty food. Siró, I., Fenyvezi, É., Szente, L., De Meulenaer, B., Devlieghere, F., Orgoványi, J., Sényi, J. and Barta, J. (2006. Release of α-tocoferol from antioxidative low density polyethylene film into fatty food simulant: Influence of complexation in β-cyclodextrin. Food Additives and Contaminants. 23:845-853) reported a method for delaying migration of α-tocopherol by first forming a complex with β-cyclodextrin, and then adding the complex during the manufacture of low-density polyethylene film. In This way the diffusivity or coefficient or diffusion (D) was delayed from 1.53E-11 cm²/sec to 1.68 E-12 cm²/sec, and from 40 to 146 days at 7° C., using ethanol as food simulator.

As can be observed, the search to control the tocopherol migration speed has been one objective in the last publications, where it is tried to reduce its migration speed towards solvents or oils, which do not objectively represent the case of real foods. According to the present invention, a novel method for controlling this migration, where the diffusion of tocopherol towards the surface of the package is accelerated, and then the tocopherol is released to the food depending on the quantity of fat contained in it and according to the need for protection against oxidation. This is achieved by adding to the polymer an adequate quantity of tocopherol, and a food grade surface modifier agent that can be glycerol monostearate, erucamide, or any other food grade surface modifier agent; that is, a compound whose use as additive in contact with foods is approved by FDA (Food and Drug Administration).

International Patent Application WO0162837 (& MX-PA/a/2002/008146) describes a mixture of polypropylene, erucamide and α-tocopherol, among other components, in the manufacture of caps for purified water bottles. In this patent, the role of antioxidant is for erucamide protection which, when decomposing, can release the breakdown products to water, influencing its taste. It is a very different function than the one described in this description.

U.S. Pat. No. 5,972,519 describes formulations for mono- or co-extruded films which, among other components, have tocopherol and erucamide. Patented properties are those of antiblocking for clear food packaging films, for the purpose of replacing their PVC-manufactured homologues. Functions of additives in this work are the traditional ones, and the tocopherol migration is not considered here.

### SUMMARY OF THE INVENTION

One purpose of the invention is to provide an active packaging that releases the antioxidant tocopherol during long time periods.

Another purpose of the invention is to provide a method for manufacturing packages for foods (such as fresh red meat, dairy products, frozen fish, oils or foods with a high proportion of non-saturated oils, almonds or seeds, powdered whole milk, etc.) or for any other pharmaceutical product or cosmetic susceptible to some type of oxidation.

Another purpose of the invention is to provide a method of manufacturing a mono- or multilayered material to be used as an antioxidant active packaging.

The above objectives are achieved by providing an antioxidant active packaging containing tocopherol, which migrates from the flexible packaging material towards the food or oxidable product, aided by any surface modifier like glycerol monostearate or erucamide, that have a portion of their molecule affine to the antioxidant, thereby accelerating migration when antioxidants migrate towards the film surface. The Controlled migration of antioxidant towards the packaged oxidable product maintains a constant quantity of tocopherol on it; this is a better benefit than that of adding great quantities of antioxidant only once, when food or product is processed or packaged.

### BRIEF DESCRIPTION OF FIGURES

FIG. 1 illustrates a schematic showing stages (a, b, c, and d) of the surface modifier self-orientation to the surface, dragging with it tocopherol, by affinity or non-polar attraction to the hydrophobic portion.

### DETAILED DESCRIPTION OF THE INVENTION

Packages in present invention may be mono- or multilayered in any combination, considering that the layer to be in contact with the food or oxidable product to be packaged is a vehicle for controlled application of tocopherol (α, β, or γ) antioxidant. Controlled migration of antioxidant towards the food has the purpose of maintaining a constant quantity of tocopherol in the food; this is a greater benefit than when adding large quantities for one time, when the oxidable product is processed or packaged. Controlled release of tocopherol from the package to the food or oxidable product is oriented or directed by one surface-modifying additive, such as glycerol monostearate, erucamide, or others of similar chemical structure, whose use in materials in contact with foods is approved for human or animal consumption, such as those FDA-approved. These additives have a portion of their molecules affine to the antioxidant, in a manner that when they migrate towards the film surface, promote its diffusion within the polymer. Tocopherol antioxidant is classified as generally recognized as safe (GRAS) and, because it is a vitamin, has no restrictions for direct use as additive in foods. Glycerol monostearate is also considered as GRAS, and the use of erucamide as additive to materials in contact with foods is also approved.

Present invention comprises the composition of a packaging material, flexible or rigid, that can be formed in greater portion by low-density polyethylene (LDPE, LLDPE, metallocene polyethylene, etc.), high-density polyethylene (HDPE) or medium-density polyethylene; polypropylene (PP, cast or bi-oriented), polyvinyl chloride (PVC), polyvinylidene chloride (PVdC), polyamides (PA), polystyrene (crystal- or high-impact polystyrene), polyethylene terepthalate (PET), polylactic acid (PLA), etc.

Tocopherol used must be of high purity (>97%) and of food-grade. It can be added in the form of concentrate or masterbatch, approved for its use in food packaging.

Preferably, the food-grade antioxidant should be added to the plastic resin making a physical pre-mixture in an in-line conditioned mixer, before entering to the extruder feed hopper. Material can be manufactured by extrusion blowing-extrusion, flat film extrusion, cast film or by blow molding. All options contemplate the co-extrusion or laminating process, in case of multilayer films or materials.

Tocopherol has following chemical structure:

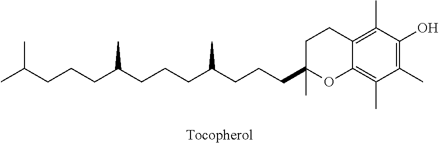

In order to increase the release of tocopherol from the material, glycerol monostearate was used; this is a surface modifier additive used in polymers as antifogging, antistatic and lubricant agent. Its direct use is allowed in food products as an emulsifying agent, and it is considered as a GRAS substance (21CFR184.1324, Code of Federal Regulations).

The molecule of glycerol monostearate contains a hydrophobic and a hydrophilic portion, as illustrated below:

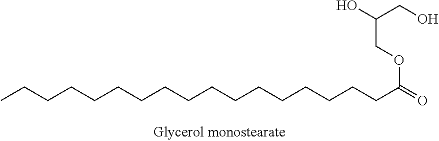

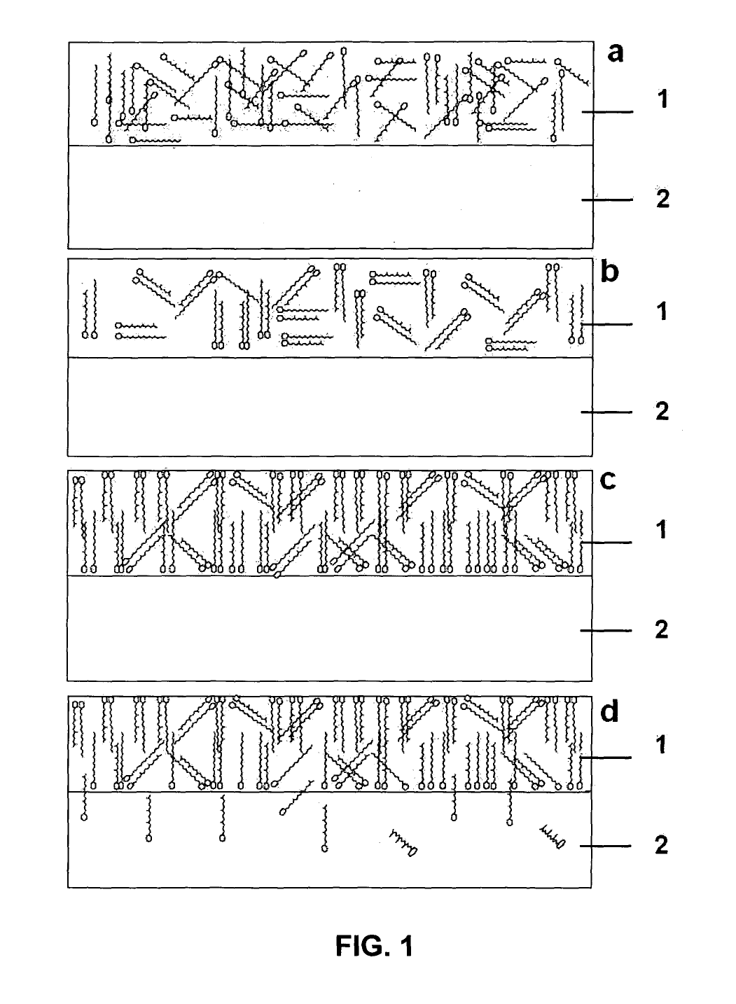

This last portion makes the additive incompatible with polyethylene, and causes its diffusion through the polymeric matrix (1), accumulating itself at the surface with its hydrophilic portion outwards, and its hydrophobic portion inwards the polymer, see FIG. 1, a, b, c; (Sakhalkar, S. S., Walters, K. B., Hirt, D. E., Miranda, N. R. and Roberts W. P. 2002. Surface characterization of LLDPE film containing glycerol monostearate. Journal of Plastic & Sheeting 18:33-43). Because of the tendency of this molecule to be oxidized, its diffusion and accumulation at the surface causes a carryover of tocopherol, which is attracted by the hydrophobic portion of glycerol monostearate.

This same effect is displayed by surface modifier additive erucamide:

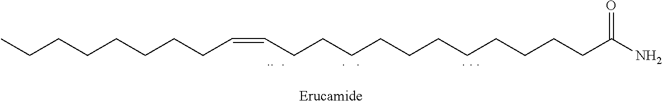

Erucamide is also considered as a lubricant, antislipping and antifogging agent. Its use is approved as additive in materials intended to be in contact with foods, such as food packaging (21CFR178.3860, Code of Federal Regulations).

The described systems promote the release of tocopherol towards the oxidable product (2) contained in the package (1) (see FIG. 1, d), and is useful in packages for foods or for products stored at different temperatures, preferably refrigeration or freezing temperatures, because at these conditions mobility of tocopherol (without surface modifier additive) through polymer matrix is low.

Next, the composition of the antioxidant active packaging material is described, either monolayer or of the outer layer from a multilayer, intended to be in contact with the food. Its particular characteristic is a greater antioxidant content than that in any traditional packaging material:

| Component | % by weight |
|---|---|
| Low-density polyethylene (LDPE, LLDPE, metallocene | ≧89 |
| polyethylene, etc.), high-density polyethylene (HDPE), or | |
| medium-density polyethylene; polypropylene (PP, cast or | |
| bi-oriented), polyvinyl chloride (PVC), polyvinylidene | |
| chloride (PVDC, polyamides (PA), polystyrene (crystal or | |
| high-impact PS), polyethylene terepthalate (PET or PETG), | |
| polylactic acd (PLA), etc. | |
| Migrating antioxidant, active compound, tocopherol (α, | 2-10 |
| β o γ). | |
| Surface modification agents: glycerol monostearate, | 0.1-1.0 |
| erucamide, or any other having similar chemical structure, | |
| whose use as additive in contact with foods is approved by | |
| FDA (in Code of Federal Regulations). | |

Described materials have a useful life of at least 12 months when stored in absence of light, at 25° C.

According to this invention, packages comprise flexible or rigid, mono- or multilayer ones. For example, rigid packages containing liquids like milk, medications or cosmetic products; or film materials for bags or envelopes formed by one or several polyethylene layers, for wrapping and storing powdered- or prepared foods, like hamburgers and sandwiches.

Other polymers useful for manufacturing the active antioxidant package, according to this invention, include low-density polyethylene (LDPE, LLDPE, metallocene polyethylene, etc.), high-density polyethylene (HDPE), or medium-density polyethylene; polypropylene (cast- or bi-oriented PP), polyvinyl chloride (PVC), polyvinylidene chloride (PVdC), polyamides (PA), polystyrene (crystal- or high-impact PS), polyethylene terephthalate (PET or PETG), or polylactic acid (PLA), etc.

### Example 1

To prove the effectiveness of this system, diffusion coefficients D were determined for tocopherol, when added to LDPE films in (a) absence, and (b) presence of glycerol monostearate, using corn oil as fatty food simulant, and at 30° C. Glycerol monostearate caused an increase of tocopherol migration velocity towards the fatty food simulant. Values for D were measured as 4.5E-11 and 4.9E-10, both in cm²/sec when (a) in absence and (b) in presence of the surface modifier, respectively. Diffusion coefficient D is 10 times greater than when no surface modifier is used.

### Example 2

In another experiment, fresh beef hamburgers were packaged in a LDPE monolayer film added with tocopherol and erucamide, and stored at 2° C. An increase of antioxidant migration speed was observed, due to the effect of erucamide, which caused an increase of shelf life with longer conservation of red color of the meat as compared to the shelf life using a film added only with tocopherol.

The monolayer film, manufactured with materials according to the present invention, and having thicknesses from 5 to 30 micrometers, maintains the red color of beef longer than when using commercial films.

In applications involving pork meat, multilayer films according to the present invention, with an oxygen transmission rate ≦300 cc/m²/24 h; they maintain the color, taste, and smell of fresh pork meat longer than commercial films, at temperatures between −1° C. and 5° C.

These films also maintain the taste and smell of processed cheese longer than commercial films, when commercially exhibited in the presence of light, at temperatures between 3 and 6° C. Also, these films keep the taste and odor of frozen fish, and the color of peeled, cooked, and frozen shrimp, longer than commercial films.

In powdered milk packaging applications, the milk without antioxidants exhibits an oxygen transmission rate ≦1.0 cc/m²/24 h, and a water vapor transmission rate ≦1.0 g/m²/24 h, as well as a light transmittance ≦2% at 400 to 500 nm; they keep the shelf life of powdered whole milk without antioxidants for a longer time than commercial films, at room temperature.

The external layer of the described material can contain another component that prevents the entrance of light, such as titanium dioxide at ≧6% in weight, or can contain an UV absorber, like benzotriazole.

In applications for packaging shelled nuts using the above mentioned light prevention compounds: they keep longer the taste, odor, and color of shelled nuts stored or exhibited in the presence of light and at room temperature, and packaged in commercial films.

Regarding the invention, as described above, it is obvious that can be varied in many forms. Such variations shall not be considered as departure from spirit and scope of the invention, as well as all modifications that are evident to those skilled in the art, and therefore are considered as comprised within the scope of following claims.

1. A material for active antioxidant packaging comprising at least 89% of polymeric substrate, to be in contact with a product vulnerable to oxidation; this material characterized by containing from 2 to 10% by weight of tocopherol antioxidant, and from 0.1 to 10% of an edible surface modifier.

2. The material for the active antioxidant packaging according to claim 1, characterized in that the polymeric material is selected among low density polyethylene (LDPE, LLDPE, metallocene polyethylene, etc.), high-density polyethylene (HOPE) or medium-density polyethylene; polypropylene (cast or bi-oriented PP), polyvinyl chloride (PVC), polyvinylidene chloride (PVdC), polyamides (PA), polystyrene (crystal- or high impact PS), polyethylene terepthalate (PET, PETG), polylactic acid (PLA), etc.

3. The material for the active antioxidant packaging according to claim 1, characterized in that the tocopherol antioxidant is selected among food-grade α-, β- or γ-tocopherol, with a purity of at least 97%.

4. The material according to claim 1, characterized in that the edible surface modifier is selected among glycerol monostearate, erucamide, or any other modifier having a hydrophobic chain of at least 10 carbon atoms, suitable for human or animal consumption or for manufacturing drugs or cosmetics, depending on the final application of the active package.

5. The material for active antioxidant packaging according to claim 1, characterized in that it also contains an UV light absorber and/or a compound that prevents the passage of light.

6. The material for active antioxidant packaging according to claim 1, characterized in that the compound preventing the passage of light is titanium dioxide in concentrations ≧6% by weight, and the UV-light absorber is benzotriazole.

7. The material for active antioxidant packaging according to claim 1, characterized in that the material is flexible or rigid.

8. The material according to claim 1, characterized in that the material is a monolayer or multilayered material.

9. The material for the active antioxidant packaging according to claim 8, characterized in that the material is a monolayer material having a thickness of from 5 to 30 micrometers.

10. The material for active antioxidant packaging according to claim 8, characterized in that the material is a multilayered material, and additional layers are selected among low-density polyethylene (LDPE, LLDPE, metallocene polyethylene, etc.), high-density polyethylene (HOPE), or medium-density polyethylene; polypropylene (cast or bi-oriented polypropylene), polyvinyl chloride (PVC), polyvinylidene chloride (PVdC), polyamides (PA), polystyrene (crystal- or high impact PS), polyethylene terepthalate (PET, PETG), polylactic acid (PLA), or combinations of them, the material being obtained using the process of co-extrusion or lamination in which an adequate adhesive for the combination has been used.

11. An active antioxidant package for products, vulnerable to oxidation, characterized in that the material is manufactured from a material according to claim 1.

12. The active antioxidant package according to claim 11, characterized in that the product, vulnerable to oxidation is selected among a foodstuff, a chemical compound, a cosmetic product, or a pharmaceutical composition.

13. A process for manufacturing a material for active oxidant packages, comprising the steps of:
a) providing a polymeric composite having at least 89% of a polymeric material that forms one surface in contact with a product vulnerable to oxidation; from 2 to 10% by weight of tocopherol antioxidant, and from 0.1 to 1% by weight of a surface modifier; and
b) forming mono- or multilayered materials of polymeric composite.

14. The manufacturing process for an active antioxidant material, according to claim 13, characterized that the surface modifier is added to it in the form of a concentrate or masterbatch.

15. The manufacturing process for an active antioxidant material according to claim 13, characterized that the material can be formed by extrusion-blowing, flat film extrusion, cast, or blow-molding.

16. The manufacturing process for an active oxidant packaging material according to claim 13, that the antioxidant is added to the plastic resin through one physical pre-mixing in an in-line conditioned mixer, before being formed.
